(19) United States
(12) Patent Application Publication
(10) Pub. No.: US 2019/0333113 A1
(43) Pub. Date: Oct. 31, 2019

(54) SYSTEM AND METHOD FOR OPTIMIZING A USER EXPERIENCE

(71) Applicants: Jordan Carlson, Newport Beach, CA (US); Stuart Harvey, Newport Beach, CA (US); Manlio De Domenico, Pergine Valsugana (IT)

(72) Inventors: Jordan Carlson, Newport Beach, CA (US); Stuart Harvey, Newport Beach, CA (US); Manlio De Domenico, Pergine Valsugana (IT)

(21) Appl. No.: 16/384,929

(22) Filed: Apr. 16, 2019

Related U.S. Application Data
(60) Provisional application No. 62/762,277, filed on Apr. 27, 2018.

(51) Int. Cl. G06Q 30/02; H04L 29/08; G10L 17/00; G10L 17/26; G01C 21/34

(52) U.S. Cl. CPC G06Q 30/0271; G06Q 30/0261; G01C 21/3476; G10L 17/005; G10L 17/26; H04L 67/22

(57) ABSTRACT

A method and system for optimizing a user's experience are disclosed. The method comprises collecting data related to a user's activities from a plurality of devices and sources. The user's activities may be current, forecasted, online, and offline activities of the user. Further, the user's future location and timestamps may be determined for being present in the future location based on the user's activities. The future locations of the user may be geo-fenced and the user may be geo-targeted, for determining presence of the user in the future locations. Thereafter, the user may be provided with suggestions that may be related with the user's future activities.

### CROSS-REFERENCE TO RELATED PATENT APPLICATION

The present application is related to and claims benefit of U.S. provisional patent application titled “System and method for optimizing a user's experience”, Ser. No. 62/762,277, filed on Apr. 27, 2018, the description of the same is incorporated herein in its entirety.

### FIELD OF THE DISCLOSURE

The present disclosure is generally related to processing of user data collected from different sources, and more particularly related to the analysis of user data for optimizing a user's experience.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

User data such as user's personal details, user's activities, and user's preferences are generally kept with different agencies. Such data is processed for business development. Processing of user data involves analysis, transformation, modeling, and investigating data primarily for discovering relevant user information. Analysis of user data comprises of multiple approaches and techniques in business, science, and other domains. A user's data may be collected from various sources and further transmitted for processing and proper organization. Thereafter, the user data could be implemented in various applications. However, an important demerit associated with the conventional techniques is an ineffective analysis of the user data resulting in an average user experience. Further, future locations or future events for the user could not be efficiently predicted for providing relevant suggestions to the user, well in time.

Thus, an efficient method to analyze the user data for optimizing the user's experience in various domains and applications is required.

### SUMMARY

According to an aspect, a method of optimizing a user's experience is provided. The method may include collecting data related to a user's activities from a plurality of devices and sources. The user's activities may include current, forecasted, online, and offline activities of the user. Subsequently, future locations of the user and timestamps for being present in the future locations may be determined based on the user's activities. Further, the future locations may be geo-fenced and the user may be geo-targeted for determining presence of the user in the future locations. Accordingly, suggestions may be provided to the user based on the user's activities. The suggestions may be related to activities to be performed in the future locations.

According to an embodiment, the method may track the user's activities by a software application installed on a user device operated by the user. Movements of the user may be tracked by at least one of access point connected with the user device, Global Positioning Sensor (GPS) in the user device, Bluetooth Low Energy (BLE) transceiver of the user device, BLE scanning device, and information provided by mobile network operator of the user device. In an embodiment, a MAC address of the user device may be utilized as a unique identity of the user or as a Universally Unique Identifier (UUID) of the user device. Further, the user's activities may be tracked by determining the user's physiological and psychological characteristics. The user's physiological and psychological characteristics may include in-application behaviour, audio-visual data captured using the user device, biometric parameters captured from the user device or external devices connected to the user device, and emotional response data during the user's activities. According to a scenario, the plurality of devices and sources may include the user device, third party online storage devices, and Network Attached Storage (NAS) devices. The suggestions may be provided in form of a text and/or a multimedia notification on the user device regarding at least one of a product, route navigation, advertisement, web link, relevant application, and contact number.

According to another aspect, a system for optimizing a user's experience is provided. The system may comprise a plurality of devices and sources for providing data related to a user's activities to an optimizing engine. The user's activities may comprise current, forecasted, online, and offline activities of the user. The system may determine future locations for the user and timestamps for being present in the future locations based on the user's activities. The optimizing engine may geo-fence the future locations and geo-target the user for determining presence of the user in the future locations. The system may also comprise a user device configured to receive suggestions based on the user's activities from the optimizing engine. The suggestions may be related to activities to be performed in the future locations.

According to an embodiment, the user device may track the user's activities by a software application installed thereon, operated by the user. The user device may track movements of the user by at least one of access point connected with the user device, global positioning sensor (GPS) in the user device, Bluetooth Low Energy (BLE) transceiver of the user device, BLE scanning device, and information provided by mobile network operator of the user device. In an exemplary scenario, the user's activities may be further tracked by determining the user's physiological and psychological characteristics. The user's physiological and psychological characteristics may include in-application behaviour, audio-visual data captured using the user device, biometric parameters captured from the user device or external devices connected to the user device, and emotional response data during the user's activities. The optimizing engine may utilize a MAC address of the user device as a unique identity of the user or as a Universally Unique Identifier (UUID) of the user device. The optimizing engine may also utilize a voice and facial characteristics of the user, as a unique identity of the user. According to a scenario, the plurality of devices and sources may be at least one of the user device, third party online storage devices, and Network Attached Storage (NAS) devices. The suggestions may be provided in form of a text and/or a multimedia notification on the user device regarding at least one of a product, route navigation, advertisement, web link, relevant application, and contact number.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a network connection diagram 100 of a system 102 for optimizing a user's experience, in an embodiment.

FIG. 2 illustrates a flowchart 200 showing a method for optimizing a user's experience, in an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

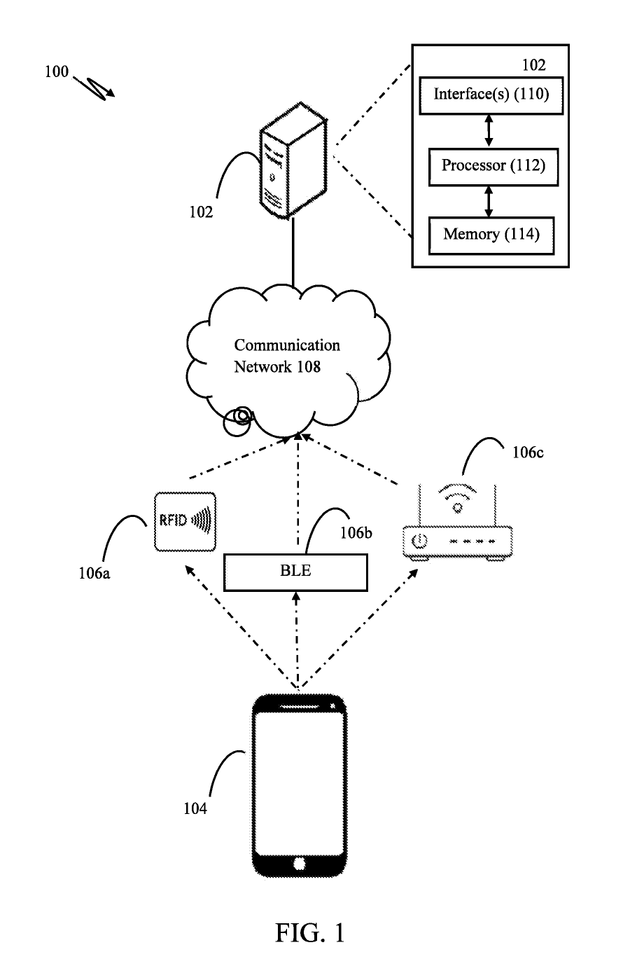

FIG. 1 illustrates a network connection diagram 100 of a system 102 for optimizing a user's experience, in an embodiment. The system 102 may be configured to receive a user's data from a user device 104 operated by the user. Location of places visited by the user and activities of the user may be detected through several devices, such as a Radio Frequency Identification (RFID) monitor 106a, Bluetooth® Low Energy (BLE) device 106b, Access Point 106c, and several others. The system 102 may receive the data from all such devices through a communication network 108. Further, the system 102 comprises an interface(s) 110, processor 112, and a memory 114. The processor 112, and the memory 114 may be present locally as parts of the system 102 and/or may be present at a distant location and accessible over a cloud.

The communication network 108 may be a wired and/or a wireless network. The communication network 108, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The interface(s) 110 may help an operator to interact with the system 102. The interface(s) 110 of the system 102 may either accept an input from the operator or provide an output to the operator, or may perform both the actions. The interface(s) 110 may either be a Command Line Interface (CLI), Graphical User Interface (GUI), or a voice interface.

The processor 112 may execute an algorithm stored in the memory 114 for optimizing the user's experience. The processor 112 may also be configured to decode and execute any instructions received from one or more other electronic devices or server(s). The processor 112 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 112 may be configured to execute one or more computer-readable program instructions, such as program instructions to carry out any of the functions described in this description. The processor 112 may be present in a server providing cloud-based services, such as Amazon™ Web Services.

The memory 114 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In one embodiment, data related to the user's activities may be obtained from a plurality of devices. The user device 104, however illustrated to be a mobile phone in FIG. 1, could be other electronic devices, such as a tablet, phablet, laptop, smart watch, fitness band, wristband, smart glasses, or other smart devices. The data related to the user's activities may be stored in a database, i.e. the memory 114 in current embodiment.

In an exemplary scenario, data related to the user's activities may be stored on databases and storage devices, such as Network Attached Storage (NAS) devices, maintained by third parties for providing their services. From such databases and storage devices, the system 102 may retrieve the user's activities through an Application Programming Interface (API). The services provided by the third parties from which data related to the user's activities could be retrieved may include Customer Relationship Management (CRM), loyalty, digital marketing hub, online ordering, point of sale, web tracking, analytics platform, or a cloud based receipt service. The processor 112 may also match the user's identity with identity information of individuals, stored in the databases and the storage devices, using various algorithms and unique identifiers. The unique identifiers may include, but are not limited to, first and last name, email address, phone number, Media Access Control (MAC) address, credit card number, and account number.

In one embodiment, the system 102 may identify an unknown device's MAC address and may pair the MAC address with the user data in terms of a location. Further, the system 102 may pair the MAC address and may track a similar location where a known user may be frequently present, in order to identify the user. The system 102 may utilize the MAC address of the user's unknown device i.e. user device 104 and may utilize a de-randomization process to identify whether the user's unknown device is present in the same place at the same time as the user was present at previous points of time. While the user has not used Open Authorization (OAuth), the system 102 may identify the user with a mathematical model pairing timestamps of known locations from sources such as GPS data, purchase data, BLE data, etc.

In an exemplary scenario, the system 102 may determine the identity of an unknown MAC address, and upon identifying the identity of the unknown MAC address, the system 102 may pair the MAC address with the user data in several ways. For instance, in a first way, the system 102 may attempt to pair the identity of the user's mobile profile with the MAC address to check if the user has associated with a WiFi network using OAuth. OAuth may allow the user to sign in using a login such as the one required for logging into Facebook, Google, Twitter, etc., without exposing the user's password. Once the user has logged in using OAuth, the social network or other sign in network may send the user's data such as first and last name, email address, phone number, gender, age, and other demographic or user related information, to the application or service with which the user is connected. A captive portal is generally used to perform such process while the user's data is transferred through WiFi. The captive portal may require the user to log in before being allowed to use the WiFi network. The WiFi network in this instance may be connected to a cloud-based system that gathers the user data once after signing in of the user. The gathered data may be sent over to the system 102 via the API. Once the system 102 receives the gathered data via the API, the system 102 may match the gathered data with the user data received from other sources and stored in the system 102, using any unique identifier associated with user. The unique identifier associated with user may be stored in the memory 114. The gathered data may be matched with the user data received from other sources to pair the unknown MAC address with the identity of a user who has identified himself on some channel such as a mobile application, website, in-store interaction, or which the operator (brand) already has stored in some database. Upon matching, the system 102 may identify presence of the user at any point when the user device 104 is located within range of a WiFi access point or Bluetooth scanning device.

In one embodiment, the system 102 may be connected to a mobile Software Development Kit (SDK) used for collecting data related to the user's activities. In one case, the system 102 may collect the data through a mobile application installed on the user device 104. The data may comprise information such as the locations of the user collected via a Global Positioning System (GPS), Wireless-Fidelity (Wi-Fi), Bluetooth and Bluetooth Low Energy (BLE) signals. Such data may be obtained from the user device or separate devices used by the user. The data may further include, but not limited to, a purchase date, purchase time, items purchased, purchase amount, tip percentage, order type, online order type, event type, last event date, sign up date, last user action date, user email, user phone number, device type/model, device OS, device language, user first name, user last name, screen viewed, user ID, application bundle ID, purchased item ID, purchased item name, purchased item price, looked item ID, looked item name, looked item price, opened coupon ID, last opened coupon date, received coupon ID, and last received coupon date. Additionally, an API may be used to pull in and aggregate data from sources such as, but not limited to, business applications. In one case, the business applications may include web and mobile analytics & tracking software, CRM, and Data Management Platforms (DMP). The sources may further include marketing automation tools, databases, Point of Sale (PoS) systems, online ordering systems, loyalty systems, digital advertising platforms, email platforms, and mobile engagement platforms.

In one embodiment, the data may be collected from camera for facial recognition, microphone for voice recognition and interaction, customer service software, call centres and call center software, social media data, and any other record, databases, CSV files, or places pertaining to the collection, import, and export of the user data. The API may be used to export data to be communicated with other system and for triggering desired actions etc.

In one embodiment, the system 102 may produce notifications while the user arrives at a store, leaves the store, interacts with various personnel, and views a product. Further, the system 102 may provide analytics and reports on whether an interaction, both digital and physical, led to a desired outcome for the user resulting in a purchase and leaving with a positive emotional reaction. Such notification may directly be provided to the user himself or another user who is present near the user and has some interest in directly engaging with the user in real life. The system 102 may collect data from a proximity based Wi-Fi AP 106c or BLE device 106b. The data may be collected as soon as the user device 104 enters within a proximity radius of the Wi-Fi AP 106c or the BLE device 106b installed at a store or other locations, such as event venues, parks, and other indoor and outdoor locations. The system 102 may implement a method to identify the user of an unknown device by pairing the location collected from the Wi-Fi AP 106c or the BLE device 106b. The system 102 may determine the user of the user device 104 by creating a database of known user locations determined by GPS, store purchase data, third party location data, and comparing through mathematical processes to identify whether the same user has been known to be present in the same locations at the same time, the user device 104 pinged the Wi-Fi AP 106c.

In one embodiment, location data may be collected from multiple parties/sources. First party data may be collected via mobile application's SDK, website location tracking, location data collected from social media sites, known location points from in-store purchases, as well as data collected from Wi-Fi APs and BLE beacons transmitted by BLE transceiver of the user device or BLE scanning device used by the user. Second party data may be collected from another company's application or any of the sources that company used to collect location data listed in first party sources. Third party data may be collected from vendors providing mobile device/advertising ID and latitude-longitude coordinates, as well as user profile data collected from browsing activity. Wi-Fi login portals use e-mail, phone number, and/or social login, thus the system 102 may receive social profile data and email addresses while users log in to Wi-Fi APs. In one case, OAuth or social profile data may also be received to match, using a unique identifier, to the user profile data collected from the other sources.

In one embodiment, the system 102 may determine the future locations pertaining to both local and global travelling plans of the user. The system 102 may determine the future locations depending upon whether the user may be travelling by foot, automobile, train, airplane, boat, ridesharing etc. The system 102 may implement various models for situations wherein the location may be continuous versus the location may be sparse.

The system 102 may pair an identity of the user by aggregating a known user data through interaction of the user device 104 with the plurality of devices. Further, the known user data may be paired with at least one of a facial recognition data from security cameras or a voice recognition data collected from microphones. The system 102 may determine location of a security camera in relation to the location of the plurality of devices connected to the user device 104. The system 102 may use at least one of the facial recognition data or the voice recognition data to identify faces pertaining to unknown devices and unknown faces to known devices, for example face pertaining to the user device 104, in one case. The system 102 may also add matching known faces to distance of the unknown MAC addresses from a particular AP and distance of a known face from the AP or from a security camera.

In an exemplary embodiment, the system 102 may target users once an unknown MAC address has been identified to correlate to a specific user. The correlation may be based on at least one of distance from access point or a group of access points, dwell time near a certain access point or group of access points, signal strength to an access point or group of access points, determination as to whether or not user has actually connected to that network, and thereby triangulating an approximate location of the user device on a floor plan from a certain access point.

In another exemplary embodiment, the system 102 may target users once an unknown BLE identifier has been identified to correlate to a specific user. The correlation may be based on at least one of distance from BLE transceiver(s), dwell time near certain BLE transceiver, signal strength to the BLE transceiver(s), determination as to whether or not user has actually connected to that network, and thereby triangulating an approximate location of the user device on a floor plan from a certain BLE transceiver.

In another exemplary embodiment, the system 102 may utilize fingerprinting technique for triangulation. The fingerprinting may allow users to be more accurately triangulated based on mapping out different device's triangulation manually. The fingerprinting may further assert that a user with a device type is present in a certain area.

As soon as the data gets collected about the location, identity of the user device 104 and a face, and the forecasting location, the system 102 may allow a business or an entity to pair the data with weather forecasts of the current location and the future location as well as a previously collected data.

The system 102 may allow layering of weather data. Layering of the weather data may assist with prediction of user behaviours, as well as for the rules/logic of when to send the message to drive most impact for the business. For example, if the weather is bad and a business is notoriously slow on days of bad weather, a message indicating an extra discount may be delivered to drive more traffic on that day. Similar approach could be made for predicting behaviour by layering of other data such as traffic, method of travel listed above via a car, plane, auto, train, foot, boat, or rideshare. Further, predictive location models may be layered to improve predictions using other data such as purchase data, day of week, seasonality, weekday or weekend, and traffic patterns.

In one embodiment, the data may be related to a place, likely activities the user might take in at a certain place, previous online behaviour, purchases, activities, health and exercise data including but not limited to medical conditions, exercise and movement tracking, calories burned, utility a customer may receive out of a previous purchase, social media posts, likes, interactions, uploads, downloads, and correlating emotional reactions, and sentiments related to an understanding of the user's mental and emotional profile.

In one embodiment, previously collected data by the system 102 may include tracked website page visits and correlating mental reactions, emotional reactions, and sentiments towards the pages viewed, forecasted and actual online behaviour, purchases, clicks, customer feedback provided via email or chat, service call transcripts, e-mails, and filled web forms. The previously collected data may further include previous real world movements, forecasted real world movements, seasonality of a business, and the user's identified patterns of a behaviour owing to a particular season. Other previously collected data may include facial movement patterns and methods listed for recognizing corresponding emotional reactions and sentiments towards an interaction with a brand, changes in volume, tonality, and inflection of the user's voice and methods listed for recognizing corresponding emotional reactions and sentiments towards an interaction with a brand. The previously collected data may also include data collection methods listed for recognizing corresponding emotional reactions and sentiments towards an interaction with a brand, data forecasting methods listed for anticipating how a digital or a real world interaction may impact the user's emotional reaction and sentiments to a digital or a real world interaction.

In one embodiment, the system 102 may utilize mathematical methods for identifying users beginning a similar path of interaction, identifying an interaction in the decision tree having a positive impact on the user's emotional reaction, and sentiments towards a brand. The mathematical methods may also recommend a path most likely to lead the user to a desired behaviour, purchase, or interaction with the brand, both online and in a digital world. The system 102 may also create databases to store all the aforementioned data and implement methods for anticipating how the current location and the forecasted location, weather, seasonality of the business, the user's preference for a seasonal, mental, and emotional profile, and relating to a relationship with the business, timing, current activities derived from assumptions, based on the location of the user data, may impact a store's traffic, purchase, digital behaviours, and digital purchases. The system 102 may adjust the interaction along the decision tree to tailor timing and content of a message, digital interaction, advertisement, interaction with a voice or a mobile assistant, physical world interaction, social media interaction, and advertisements.

In one embodiment, the system 102 may implement methods for analyzing an impact of the aforementioned parameters on behaviours, purchase decisions, location behaviours related to the user's mobility, emotional state, emotional reactions, and sentiments towards the business. The system 102 may make the data actionable to the business in a way anticipating what the user may expect from the business in various imaginable circumstances.

In one embodiment, the system 102 may determine current and future emotional and mental states of a human. The methods may be based on neural networks and methods for using simulated neural networks to forecast an impact of a message, interaction, or advertisement on the user's brain's own neural networks. The system 102 may provide recommendations based on a research determining the messages leading to a desired neural response, current and future mental and emotional states, sentiments toward the business, in turn leading to an increase in a desired behaviour. In one case, the desired behaviour may include, but not be limited to, purchase of various items, communicating with others in a social circle about the business in a positive way, visiting a desired location, and other desired actions.

In one embodiment, the system 102 may utilize APIs to transmit a message to the user on a particular channel, at a particular time, and in a particular location. Using the APIs, messages may directly be sent by the system 102 itself. The APIs may also transmit the message before the user may reach the forecasted location, with a particular content based on a recommendation of the system 102 stating a medium and a timing of message transmission to the user. The APIs may also transmit the message through other digital marketing platforms, such as HubSpot, Salesforce, Marketo, Web CEO, and others.

In one embodiment, the paired data may be received at the interface 110 of the system 102. The paired data may be analyzed by the processor 112 and, finally, saved in the memory 114. The paired data, post analysis by the processor 112, may be used to recommend a best possible interaction between the user and the business in order to optimize the user's experience. A process of recommending the best possible interaction between the user and the business in order to optimize the user's experience may be called customer journey automation. The system 102 may identify the user's intent or desire by analyzing all the aforementioned parameters, for example to identify when the user may be hungry or wishes to purchase a new pair of shoes. The process of customer journey automation replaces a need for the business to manually map out a decision tree and automate a process based on mathematical methods that includes content, channel, and timing.

In one embodiment, the methods described above may be used for implementing a curb side pickup service. A store employee may be notified by an operator upon arrival of a user in a store, after the user has placed an order for curb side pickup. Further, the operator could provide real time updates about predicted arrival times to store employees to allow them to prepare the order. Also, the operator could send notifications to a person responsible for order delivery as the user comes near the store. Such notifications could be issued based on a projected arrival time of the user.

In the above described embodiments, the notifications could be provided as push notifications. The notifications may also include deep links. Upon opening a notification, the user may be directed to any web link or application screen. Further, the user may be notified using in-app content that may allow an application to display an image with a deep link or store route once a notification has been opened. The application may be opened by the user, at a desired time, to send a notification. After such notification is sent, a message may be displayed to the user, within the application.

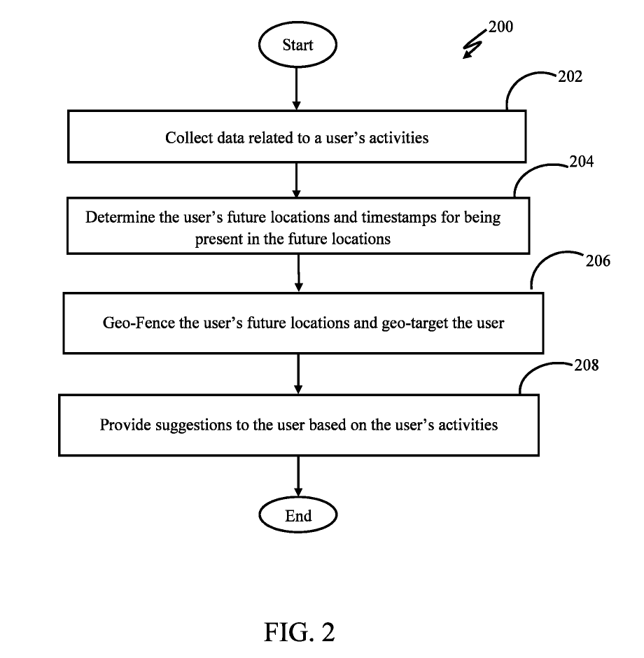

FIG. 2 illustrates a flowchart 200 showing a method for optimizing the user's experience, in an embodiment. FIG. 2 comprises a flowchart 200 that is explained in conjunction with the elements disclosed in FIG. 1.

The flowchart 200 of FIG. 2 shows the architecture, functionality, and operation for optimizing the user's experience. In this regard, each block may represent a module, segment, or a portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 210.

At step 202, data related to a user's activities may be collected from a plurality of devices. The user's activities may comprise current, forecasted, online, and offline activities of the user. In an embodiment, the user's activities may be tracked by determining the user's physiological and psychological characteristics. The user's physiological and psychological characteristics may include in-application behaviour, audio-visual data captured using the user device, biometric parameters captured from the user device or external devices connected to the user device, and emotional response data during the user's activities.

At step 204, future locations and timestamps of the user may be determined for being present in the future locations based on the user's activities.

At step 206, the future locations may be geo-fenced and the user may be geo-targeted for determining presence of the user in the future locations.

At step 208, suggestions may be provided to the user, based on the user's future locations.

Embodiments of the present disclosure may be provided as a computer program product which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

1. A method of optimizing a user's experience, the method comprising:
collecting, from a plurality of devices and sources, data related to a user's activities, wherein the user's activities comprise current, forecasted, online, and offline activities of the user;
determining, for the user, future locations and timestamps for being present in the future locations based on the user's activities;
geo-fencing the future locations and geo-targeting the user for determining presence of the user in the future locations; and
providing, to the user, suggestions based on the user's activities, wherein the suggestions are related to activities to be performed in the future locations.

2. The method of claim 1, wherein the user's activities are tracked by a software application installed on a user device operated by the user.

3. The method of claim 2, further comprising tracking movements of the user by at least one of access point connected with the user device, Global Positioning Sensor (GPS) in the user device, Bluetooth Low Energy (BLE) transceiver of the user device, BLE scanning device, and information provided by mobile network operator of the user device.

4. The method of claim 2, further comprising utilizing a MAC address of the user device as a unique identity of the user or as a Universally Unique Identifier (UUID) of the user device.

5. The method of claim 1, further comprising utilizing a voice and facial characteristics of the user, as a unique identity of the user.

6. The method of claim 2, further comprising tracking the user's activities by determining the user's physiological and psychological characteristics.

7. The method of claim 6, wherein the user's physiological and psychological characteristics include in-application behaviour, audio-visual data captured using the user device, biometric parameters captured from the user device or external devices connected to the user device, and emotional response data during the user's activities.

8. The method of claim 1, wherein the plurality of devices and sources include the user device, third party online storage devices, and Network Attached Storage (NAS) devices.

9. The method of claim 1, wherein the suggestions comprise a text and/or a multimedia notification regarding at least one of a product, route navigation, advertisement, web link, relevant application, and contact number.

10. A system for optimizing a user's experience, the system comprising:
a plurality of devices and sources for providing data related to a user's activities to an optimizing engine, wherein the user's activities comprise current, forecasted, online, and offline activities of the user;
the optimizing engine configured to:
determine, for the user, future locations and timestamps for being present in the future locations based on the user's activities; and
geo-fence the future locations and geo-target the user for determining presence of the user in the future locations; and
a user device configured to receive suggestions based on the user's activities from the optimizing engine, wherein the suggestions are related to activities to be performed in the future locations.

11. The system of claim 10, wherein the user device tracks the user's activities by a software application installed thereon, operated by the user.

12. The system of claim 11, further comprising tracking movements of the user by at least one of access point connected with the user device, Global Positioning Sensor (GPS) in the user device, Bluetooth Low Energy (BLE) transceiver of the user device, BLE scanning device, and information provided by mobile network operator of the user device.

13. The system of claim 11, further comprising tracking the user's activities by determining the user's physiological and psychological characteristics.

14. The system of claim 13, wherein the user's physiological and psychological characteristics include in-application behaviour, audio-visual data captured using the user device, biometric parameters captured from the user device or external devices connected to the user device, and emotional response data during the user's activities.

15. The system of claim 10, wherein the optimizing engine utilizes a MAC address of the user device as a unique identity of the user or as a Universally Unique Identifier (UUID) of the user device.

16. The system of claim 10, wherein the optimizing engine utilizes a voice and facial characteristics of the user, as a unique identity of the user.

17. The system of claim 10, wherein the plurality of devices and sources include the user device, third party online storage devices, and Network Attached Storage (NAS) devices.

18. The system of claim 10, wherein the suggestions comprise a text and/or a multimedia notification regarding at least one of a product, route navigation, advertisement, web link, relevant application, and contact number.

19. The system of claim 10, further comprising deriving the user's identity by comparing timestamps from known locations of a user after the user device is connected to an access point.

20. The system of claim 10, further comprising deriving the user's identity by matching an identifier related to the user with unique identifier of known users, stored in a mobile application or other databases, wherein the identifier related to the user is obtained through captive portal identifiers comprising social details, email, or phone number.
